(19) United States
(12) Patent Application Publication
(10) Pub. No.: US 2023/0002536 A1
(43) Pub. Date: Jan. 5, 2023

(54) MANUFACTURE OF FIBER REINFORCED COMPOSITE MATERIALS WITH ISOCYANATE RESIN

(71) Applicant: TRIMER TECHNOLOGIES LLC, ANN ARBOR, MI (US)

(72) Inventor: HENRY A. SODANO, ANN ARBOR, MI (US)

(73) Assignee: TRIMER TECHNOLOGIES, LLC, ANN ARBOR, MI (US)

(21) Appl. No.: 17/771,242

(22) PCT Filed: Oct. 22, 2020
(86) PCT No.: PCT/US20/56766

§ 371 Date: Apr. 22, 2022

Related U.S. Application Data
(63) Continuation of application No. 17/532,539, filed on Nov. 22, 2021.
Application No. 17/532,539 is a continuation-in-part of application No. 17/029,998, filed on Sep. 23, 2020, now Pat. No. 11,180,599.
Application No. 17/029,998 is a continuation of application No. PCT/US2019/065711, filed on Dec. 11, 2019.
(60) Provisional application No. 62/924,534, filed on Oct. 22, 2019.
(60) Provisional application No. 62/777,792, filed on Dec. 11, 2018.

(51) Int. Cl. C08G 18/02; C08G 18/16

(52) U.S. Cl. CPC C08G 18/022; C08G 18/168

(57) ABSTRACT

A method of producing a reinforced polymer composite includes placing reinforcement solids a die defining a die cavity. A liquid reaction mixture including an aromatic polyisocyanate and initiating reaction of said aromatic polyisocyanate is infused with a catalyst composition forming an aromatic isocyanurate based polymer reaction mixture impregnates the reinforcing solids with using the cavity for forming the aromatic isocyanurate based polymer reaction mixture. The cavity defined by the die is heated to at least 80° C. for a period required to form a polymer reaction product producing the reinforced polymer composite.

### PRIOR APPLICATIONS

The present application is a national application of Patent Cooperation Treaty Patent Application No. PCT/US2020/056766 filed Oct. 22, 2020 that claims priority to U.S. Provisional Patent Application No. 62/924,534 filed on Oct. 22, 2019, and claims priority as a continuation patent application to co-pending U.S. patent application Ser. No. 17/532,539 filed on Nov. 22, 2021; and claims priority as a continuation-in-part patent application to U.S. patent application Ser. No. 17/029,998, filed on Sep. 23, 2020, which is a continuation patent application of Patent Cooperation Treaty Patent Application No. PCT/US2019/065711, filed on Dec. 11, 2019, which claims priority to U.S. Provisional Patent Application No. 62/777,792 filed on Dec. 11, 2018, the contents each of which are incorporated herein by reference in their entirety.

### TECHNICAL FIELD

The present invention relates generally to the manufacture of fiber reinforced composites which exhibit high strength, stiffness and fire resistance through the infusion of resin into a fiber preform which is located in a die cavity and subjecting the molded resin infused fibers in the die cavity to heat such that the resin cures and forms a rigid fiber reinforced composite.

### BACKGROUND

Fiber reinforced polymer matrix composites are widely used for their lightweight and high strength which makes them useful in a range of industries including construction of automobiles, wind turbines, sporting goods, aerospace structures, pressure vessels, building materials, and printed circuit boards. However, the end use of the fiber-reinforced plastic molded part may be applied to other applications as would be known to one of ordinary skill in the art.

The manufacturing processes used for the production of composites parts typically falls into two separate categories, prepregs or infusion resins. Prepregs consist of reinforcing fibers, either continuous or discontinuous, which are pre-impregnated with the resin such that it can be handled and then subsequently molded and cured. Prepregs include continuous fiber reinforced tapes and fabrics as well as discontinuous fibers, also known as chopped fibers, which are termed Sheet Molding Compound (SMC) or Bulk Molding Compound (BMC) and often exhibit a high degree of latency allowing the infused fibers to have an improved shelf-life. Resin Transfer Molding (RTM) resins are flowable either at room temperature or when heated such that they can be infused into the reinforcing fibers and subsequently cured. It is desirable for the infusion resin to be of a sufficiently low viscosity to allow the resin to flow into the fibers with minimal time. RTM resins are most often infused into the fibers in a mold which is then cured to give a desired final shape. Control of flow rates in combination with desirable reaction times and viscosity has proven elusive.

The formation of polyisocyanurates is known to be a slow process which is often considered a secondary reaction in the formation of polyurethanes and polyureas. Isocyanurates are formed through the trimerization of three isocyanates and have been widely used for decades to increase the thermal stability of polyurethanes, epoxies and polyureas. Isocyanurates are also widely used in the production of foams due to its excellent flammability resistance, however high density polymers based essentially on polyisocyanurates alone have not found use without the formation of additional linkages which act to increase the toughness of the polymer. To overcome a defect widely known as friability of polyisocyanurate foams or brittleness, polyisocyanurates have required an inclusion of high percentages of reactants that consume isocyanate groups and limit the fraction of isocyanurates in the polymer. U.S. Pat. No. 3,676,380A describes the use of 1 to 10% of an aliphatic diol to form polyurethane linages which increase the elasticity of the polymer. U.S. Pat. No. 3,793,236 describes trimerizing an isocyanate-terminated polyoxazolidone prepolymer by means of a trimerization catalyst such as a tertiary amine. The inventors describe the resulting polymer as exhibiting low friability and high flame resistivity due to the incorporation of oxazolidone linkages. CN Pat. App. Pub. No. 103,012,713A discloses that foams with a high degree of pure polyisocyanurate crosslinking density have very brittle properties and “no practical value.” The inventors use 10-50% epoxy resin to achieve reduced brittleness.

When polyisocyanurates are used in the production of dense plastics with a low void content, the materials are widely known to be brittle without the incorporation of linear bonds, chain extenders or flexible groups that act to increase toughness, i.e. oxazolidones disclosed in U.S. Pat. Nos. 3,793,236; 8,501,877; U.S. Pat. App. Pub. No. 2010/0151138A1); urethanes disclosed in (EP Pat. Nos. 226,176B1; EP 0,643,086A1 U.S. Pat. Nos. 9,334,379; 9,334,379); and ureas disclosed in U.S. Pat. No. 6,617,032 B2; and CN Pat. No. 103,568,337B). For instance, U.S. Pat. No. 4,564,651 teaches cured isocyanate/epoxy blends with an epoxy to isocyanate ratio less than 1:5 are extremely brittle and get increasingly worse with increasing concentration of diphenylmethane diisocyanate concentration (MDI) and U.S. Pat. No. 5,036,135 teaches that that when less than 20% epoxy is included in the polyisocyanurate polymer, it exhibits poor mechanical properties. These two patents teach that it is not possible to obtain a polymer with high strength and toughness with less than 20% epoxy or less than 20% oxazolidone which is the result of the reaction between an isocyanate and an epoxy at high temperature. EP Pat. App. No. 3,189,088A1 further teaches that “polyisocyanurate comprising materials are known to be very difficult to toughen and some may be too brittle to toughen effectively” and “attempts to increase the fracture toughness in the past often came at the expense of changes (typically reduction) in modulus and of reductions in thermal properties e.g. glass transition temperature (T_{g}) thereby creating unacceptable limits on the applicability of the resulting composite.”

US Pat. App. Pub. No. 2018/0051119 A1 teaches that the molar ratio of the at least one epoxy resin to the at least one isocyanate resin should be at least 0.4:1 and most preferably 1:1 and that this ratio leads to “particularly advantageous properties with the glass transition temperature, the modulus of elasticity and impact resistance.” These preferred ratios far exceed catalytic amounts of epoxy to achieve desirable tensile strength, tensile stiffness and tensile strain to failure results. Furthermore, the aforementioned patents clearly teach that polymers and foams composed essentially of polyisocyanurates exhibit a high degree of brittleness.

While the prior art references described above disclose various efforts to improve physical properties of polymers containing polyisocyanurates by reacting various active hydrogen containing molecules. Accordingly, there is a need for improvement for a cured composition which is essentially free of the reaction product of these moieties and provides the high strength, high stiffness, high strain to failure, high toughness and high glass transition temperature required by modern polymers, fiber reinforced polymers and adhesives.

### SUMMARY

The present invention relates to low room temperature viscosity RTM resins that are composed primarily of an isocyanate reaction mixture that includes polymeric methylene diphenyl diisocyanate (pMDI) of the time disclosed in co-pending U.S. patent application Ser. No. 17/029,998, the contents of which are included herein by reference for brevity of the present application, and their use in the manufacture of fiber reinforced composites through resin transfer molding or pultrusion. The predominately isocyanate infusion resin is mixed with a catalyst and subsequently infused into the reinforcing fibers through wet infusion, resin transfer molding, vacuum assisted resin transfer molding (VARTM), reaction injection molding, high pressure resin transfer molding (HP-RTM) or pultrusion and cured through heating the polymer such that it cures to the form of the mold. The cured fiber reinforced composites possess high strength, high stiffness, high glass transition temperature and fire resistance.

The reaction mixture described in the present invention has found that can be infused into a fiber preform and cure to form a rigid composite with a high glass transition temperature in under 10 minutes and in particular in least 5 minutes, and in another embodiment at least 3 minutes and in still a further embodiment can be cured in 90 seconds or less.

One embodiment of the invention provides a method for producing a fiber reinforced polymer matrix composite through resin transfer molding; the method comprising the following steps. First a die cavity or open mold is provided. As used herein, “die” and “die” cavity is any tooling used to form composites whether through batch process or continuous process, including, but not limited to injection mold tooling, clam shell type tooling, pultrusion tooling and the like. Next, reinforcing fibers are placed or arranged in the die or mold. In refinement, the fibers are inserted into the die in either a batch process or continuously as performed during pultrusion. Alternatively, the fibers can be wet infused from a bath or closed injection box and wound onto a mandrel. It should be understood that fibers or solids can be woven and even wetted or impregnated with reaction mixture prior to entering the die cavity or equivalent forming tooling. Further, as used herein, reinforcing solids includes fibrous materials, such as, for example fiber glass, carbon fibers, woven fibers or any fibrous material that enhances mechanical properties of a structural part. Still further, reinforcing solids includes particulate solids such, for example graphene, zeolite, or any other particulate solid that enhances mechanical properties of a structural part. Next, a liquid reaction mixture is provided. The liquid reaction mixture comprises at least one liquid, aromatic polyisocyanate and a catalyst composition. In refinement, the liquid reaction mixture can also comprise at least one liquid, aliphatic polyisocyanate. In refinement, the liquid reaction mixture can comprise a internal mold release agent. In another embodiment, the reaction mixture is polysiloxane or and equivalent. However, alternative types of internal release agents are also within the scope of this invention.

Next, the liquid reaction mixture is infused into the mold or die containing fibers. In refinement, this infusion occurs by high pressure resin transfer molding (HP-RTM), wet infusion, resin transfer molding, vacuum assisted resin transfer molding (VARTM) or reaction injection molding. In refinement the reaction mixture may be infused at room temperature or heated to reduce the viscosity to less than 1,000 cP for infusion.

Next, the die or mold is heated to at least 80° C. to cure the reaction mixture infused into the reinforcing fibers through the self-reaction of the isocyanate groups. Finally, the cured fiber reinforced composite is removed from the die cavity or mold.

In further refinement, the at least one aromatic polyisocyanate includes polymeric methylene diphenyl diisocyanate (pMDI) such that the at least one aromatic polyisocyanate has an average functionality greater than 2.1, in particular at least 2.2, or at least 2.5 and even greater than 2.7. In refinement, the catalyst composition includes at least one epoxide which may be monofunctional or polyfunctional in a proportion to the total reaction mixture of up to 10%, in particular between 0.01% and 5%. In an alternative embodiment, the catalyst composition includes at least one epoxide which may be monofunctional or polyfunctional in a proportion to the total reaction mixture of up to 10%. In further refinement, the catalyst composition includes at least one epoxide which may be monofunctional or polyfunctional in a proportion to the total reaction mixture of between 0.5% and 4%. In further refinement, the catalyst composition includes at least one epoxide which may be monofunctional or polyfunctional in a proportion to the total reaction mixture of between 1.0% and 2.5% and in a further embodiment 2%.

In another embodiment, the liquid reaction mixture includes a room temperature viscosity below 2,000 cP. In yet another embodiment, the liquid reaction mixture should have a viscosity below 1,000 cP when heated to 70° C. Still further, the liquid reaction mixture includes a room temperature viscosity of at 250 cP and at 70° C. a viscosity of 20 cP. It should be understood that viscosity of the liquid reaction mixture can be tailored for a particular application, such as, for example restricted volume die cavities and the like to avoid voids or other defects that could occur when viscosity has not been optimized.

In yet another refinement, when the die or mold is heated to between 80° C. and 120° C. the reaction mixture infused into the fiber's cures in under 2 hours. In another refinement, when the die or mold is heated to between 120° C. and 150° C., the reaction mixture infused into the fiber's cures in under 1 hour. In another refinement, when the die or mold is heated to between 120° C. and 180° C., the reaction mixture infused into the fiber's cures in under 10 minutes. In another embodiment, the die or mold is heated to between 100° C. and 180° C. resulting in a cured fiber reinforced composite in less than 5 minutes. In another refinement, the die is heated to between 100° C. and 180° C. resulting in a cured fiber reinforced composite in a less than 3 minutes. In another refinement, the die is heated to between 100° C. and 180° C. resulting in a cured fiber reinforced composite in a less than 1 minute.

The cured composition also displays unexpected, and significant increases in glass transition temperature (Tg) when subject to ambient aging. The cured composition displays a Tg above 160° C. independent of the temperature at which the composition is cured. In another refinement and upon aging of the cured reinforced composition for several weeks under ambient conditions the Tg continues to increase above 300° C.

### DETAILED DESCRIPTION

“At least one,” as used herein, refers to 1 or more, for example 1, 2, 3, 4, 5, 6, 7, 8, 9, or more. In connection with components of the catalyst compositions described herein, this information does not refer to the absolute amount of molecules, but to the type of the component. “At least one epoxy resin” therefore signifies, for example, one or more different epoxy resins, which is to say one or more different types of epoxy resins. Together with quantities, the quantities refer to the total amount of the correspondingly identified type of component, as already defined.

“Liquid,” as used herein, denotes compositions that are flowable at room temperature (20° C.) and normal pressure (1,013 mbar).

When referring to a chemical moiety, “Substantially Free” means a molar fraction of molecules containing that particular moiety of less than 10% in the reaction mixture or cured composition. In some cases, “Substantially Free” means the molar fraction of molecules containing that particular moiety of less than 7.5% and even less than 5% in the reaction mixture or cured composition.

The viscosity of the liquid composition described herein is in particular low enough for the composition to be pumpable and capable of wetting and impregnating fiber materials, for example, such as are used for fiber-reinforced plastic parts. In one embodiment of the invention the reaction mixture has a viscosity between 100 and 300 cP at room temperature and a viscosity of 10 to 50 cP when heated to 65° C. In various embodiments, the reaction mixture has a viscosity of less than 50 cP at a temperature of 50° C. So as to determine the viscosity, the resin mixture is produced at room temperature using a suitable mixer, and the viscosity is determined on a spindle type rheometer.

The present invention has found that the infusion of reinforcing fibers with a predominately isocyanate reaction mixture that includes polymeric methylene diphenyl diisocyanate (pMDI), and a catalyst results in a cured composition with high strength, Young's modulus, glass transition, and toughness. The reaction mixture is composed primarily of isocyanates and substantially free of polyols and polyamines.

In the present invention, a dense polymer is one that is substantially free of voids with a void content less than 10% and even less than 2%. The present invention achieves a fiber reinforced composite articles with high strength, fracture toughness and high glass transition temperature (greater than 160° C.), through the polymerization of a reaction mixture of containing polymeric methylene diphenyl diisocyanate and a catalytic amount of epoxy while being substantially free of molecules containing active hydrogen moieties such as hydroxyls, primary and secondary amines, carboxylic acids, thiols, and others known to one of skill in the art. The present invention further demonstrates that contrary to expectations, the presence of aliphatic uretdione, aliphatic trimer, or aliphatic iminooxadiazinedione which are reaction products of two or three aliphatic isocyanates accelerates the polymerization reaction enabling greater isocyanate conversion and improved mechanical strength at lower cure temperature.

The cured fiber reinforced composite resulting from the polymerization of the essentially isocyanate reaction mixture lacks fracture toughness and strength without the use of polymeric methylene diphenyl diisocyanate (pMDI) as a fraction of the reaction mixture. Therefore, it is desirable to produce an average isocyanate functionality greater than 2.1, in particular at least 2.2, more preferably at least 2.5 and still more preferably greater than 2.7 is selected. The present invention includes epoxy in an amount representative of being a catalyst and therefore does not significantly affect material properties.

Oligomeric MDI in the sense of this application means a polyisocyanate mixture of higher-nuclear homologues of MDI, which have at least 3 aromatic nuclei and a functionality of at least 3. The term “polymeric diphenylmethane diisocyanate”, “polymeric MDI”, “Oligomer MDI” or pMDI is used in the context of the present invention to refer to a mixture of oligomeric MDI and optionally monomeric MDI. Typically, the monomer content of the polymeric MDI is in the range from 25 to 85 wt. %, based on the total mass of the pMDI such that the average functionality is greater than about 2.1.

In addition to pMDI, the isocyanate mixture in step 1) may contain monomeric or oligomeric isocyanates. Monomeric isocyanate includes the customary aliphatic, cycloaliphatic, and aliphatic di- and/or polyisocyanates and especially aromatic isocyanates which are known from polyurethane chemistry. Aromatic isocyanates, especially the isomers of the MDI series (monomeric MDI) and TDI are particularly beneficial.

Isocyanates useful in embodiments disclosed herein may include isocyanates, polyisocyanates, isocyanate carbodiimides, uretidiones and trimers composed of such isocyanates. Suitable polyisocyanates include any of the known aromatic, aliphatic, alicyclic, cycloaliphatic, and araliphatic di- and/or polyisocyanates. Inclusive of these isocyanates are variants such as uretidiones, isocyanurates, carbodiimides, iminooxadiazinedione, among others which are produced through the reaction between isocyanates.

Suitable aromatic diisocyanate compounds may include for example xylylene diisocyanate, metaxylylene diisocyanate, tetramethylxylylene diisocyanate, tolylene diisocyanate, 4,4′-diphenylmethane diisocyanate, 1,5-naphthalene diisocyanate, 1,4-naphthalene diisocyanate, 4,4′-toluidine diisocyanate, 4,4′-diphenyl ether diisocyanate, m- or p-phenylene diisocyanate, 4,4′-biphenylene diisocyanate, 3,3′-dimethyl-4,4′-biphenylene diisocyanate, bis(4-isocyanatophenyl)-sulfone, isopropylidenebis (4-phenylisocyanate), and the like. Polyisocyanates having three or more isocyanate groups per molecule may include, for example, triphenylmethane-4,4′,4″-triisocyanate, 1,3,5-triisocyanato-benzene, 2,4,6-triisocyanatotoluene, 4,4′-dimethyldiphenylmethane-2,2′,5,5′-tetraisocyanate, and the like. Aliphatic polyisocyanates may include hexamethylene diisocyanate, 1,4-Diisocyanatobutane, 1,8-Diisocyanatooctane, m-xylylene diisocyanate, p-xylylene diisocyanate trimethylhexamethylene diisocyanate, dimeric acid diisocyanate, lysine diisocyanate and the like, and the uretdione-type adducts, carbodiimide adducts and isocyanurate ring adducts of these polyisocyanates. Alicyclic diisocyanates may include isophorone diisocyanate, 4,4′-methylenebis(cyclohexylisocyanate), methylcyclohexane-2,4- or -2,6-diisocyanate, 1,3- or 1,4-di(isocyanatomethyl)cyclohexane, 1,4-cyclohexane diisocyanate, 1,3-cyclopentane diisocyanate, 1,2-cyclohexane diisocyanate, and the like, and the uretdione-type adducts, carbodiimide adducts and isocyanurate ring adducts of these polyisocyanates.

The reaction mixture may comprise 15 to 85% polymeric MDI, 15 to 85% Diphenylmethane Diisocyanate isomers and homologues. The reaction mixture may comprise 15 to 85% polymeric MDI, 25-65% Diphenylmethane Diisocyanate isomers and homologues and 2-20% the uretdione of hexamethylene diisocyanate. The reaction mixture may comprise 15 to 85% polymeric MDI, 25 to 65% Diphenylmethane Diisocyanate isomers and homologues and 2 to 20% the trimer of hexamethylene diisocyanate.

Surprisingly, the cured composition formed in step 2) of this invention achieves a greater isocyanate conversion when the reaction mixture contains aliphatic uretdione, aliphatic isocyanurate, or aliphatic iminooxadiazinedione, enabling the cured composition to obtain high mechanical properties at lower reaction temperature than in their absence. This result is unexpected since aliphatic isocyanates are known to react more slowly than aromatic isocyanates however in the reaction mixture of step 1) the reactivity is enhanced. Uretidiones, isocyanurates, carbodiimides and iminooxadiazinediones are the reaction product of 2 or 3 isocyanates as shown below where x, x′ and x″ may be the same or different aliphatic linages with a terminal isocyanate group.

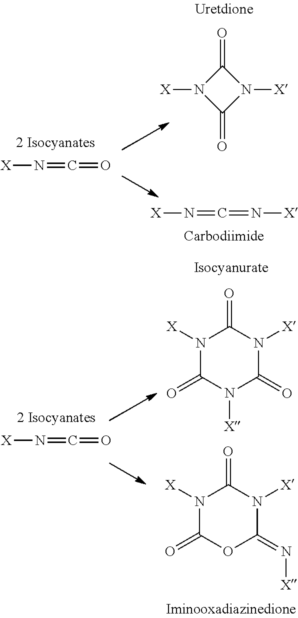

Mixtures of any of the above-listed isocyanates may, of course, also be used. Furthermore, there are many different orders of contacting or combining the compounds required to make the polyisocyanurate comprising reaction mixture of the present invention. One of skill in the art would realize that blending or varying the order of addition of the compounds falls within the scope of the present invention.

### Catalyst Composition

The reaction mixture is cured via a catalyst composition which induces trimerization of the polymer. Trimerization catalysts may include amine catalysts such as N,N-Dimethylbenzylamine (BDMA), 4-Dimethylaminopyridine (DMAP), 2-Dimethylaminopyridine (DMAP), 1,4-diazabicyclo[2.2.2]octane or Triethylenediamine (DABCO), Bis-(2-dimethylaminoethyl)ether (BDMAEE), 1,8-Diazabicyclo[5.4.0]undec-7-ene (DBU), 1,5-Diazabicyclo[4.3.0]non-5-ene (DBN), N-alkylmorpholines, N-alkylalkanolamines, Tris(Dimethylaminopropyl) Hexahydrotriazine, N,N-dialkylcyclohexylamines, and alkylamines where the alkyl groups are methyl, ethyl, propyl, butyl and isomeric forms thereof, and heterocyclic amines. Amine catalysts also include quaternary ammonium hydroxides and quaternary ammonium salts such as benzyl trimethyl ammonium hydroxide, benzyl trimethyl ammonium chloride, benzyl trimethyl ammonium methoxide (2-hydroxypropyl)trimethylammonium 2-ethylhexanoate, (2-hydroxypropyl)trimethylammonium formate and the like. In one embodiment, BDMA and in another embodiment BDMAEE and in another embodiment DABCO dissolved in nitro or nitrile solvents are used in the catalyst composition at weights between 0.001 and 10 wt. % and more preferably between 0.1 and 3 wt. %.

Non-amine catalysts may also be used. Organometallic compounds of bismuth, lead, tin, potassium, lithium, sodium, titanium, iron, antimony, uranium, cadmium, cobalt, thorium, aluminum, mercury, zinc, nickel, cerium, molybdenum, vanadium, copper, manganese, and zirconium, may be used. Illustrative examples include potassium acetate, potassium naphtholate, potassium octoate, potassium 2-ethylhexanoate, bismuth nitrate, lead 2-ethylhexonate, lead benzoate, ferric chloride, antimony trichloride, stannous acetate, stannous octoate, and stannous 2-ethylhexonate.

In other embodiments, suitable catalysts may include imidazole compounds including compounds having one imidazole ring per molecule, such as imidazole, 2-methylimidazole, 2-ethyl-4-methylimidazole, 2-undecylimidazole, 2-heptadecylimidazole, 2-phenylimidazole, 2-phenyl-4-methylimidazole, 1-benzyl-2-methylimidazole, 2-ethylimidazole, 2-isopropylimidazole, 2-phenyl-4-benzylimidazole, 1-cyanoethyl-2-methylimidazole, 1-cyanoethyl-2-ethyl-4-methylimidazole, 1-cyanoethyl-2-undecylimidazole, 1-cyanoethyl-2-isopropylimidazole, 1-cyanoethyl-2-phenylimidazole, 2,4-diamino-6-[2′-methylimidazolyl-(1)′]-ethyl-s-triazine, 2,4-diamino-6-[2′-ethyl-4-methylimidazolyl-(1)′]-ethyl-s-triazine, 2,4-diamino-6-[2′-undecylimidazolyl-(1)′]-ethyl-s-triazine, 2-methylimidazolium-isocyanuric acid adduct, 2-phenylimidazolium-isocyanuric acid adduct, 1-aminoethyl-2-methylimidazole, 2-phenyl-4,5-dihydroxymethylimidazole, 2-phenyl-4-methyl-5-hydroxymethylimidazole, 2-phenyl-4-benzyl-5-hydroxymethylimidazole and the like; and compounds containing 2 or more imidazole rings per molecule which are obtained by dehydrating above-named hydroxymethyl-containing imidazole compounds such as 2-phenyl-4,5-dihydroxymethylimidazole, 2-phenyl-4-methyl-5-hydroxymethylimidazole and 2-phenyl-4-benzyl-5-hydroxymethylimidazole; and condensing them by deformaldehyde reaction, e.g., 4,4′-methylene-bis-(2-ethyl-5-methylimidazole), and the like.

Optionally, a latent catalyst, such as those described in U.S. Pat. No. 9,334,379, can be used to delay the curing reaction. Such latent catalysts are known to one skilled art and are commonly used in the preparation of prepreg, sheet molding compound (SMC) and bulk molding compound (BMC). Additionally, 2-(Dimethylamino)pyridine may be used as a latent catalyst.

The catalyst may also include a co-catalyst of at least one epoxy resin. The co-catalyst behavior of epoxy resin has been reported in U.S. Pat. No. 2,979,485. The epoxy resin may include epoxide group-containing monomers, prepolymers and polymers and mixtures thereof, and is hereafter also referred to as an epoxide or epoxide group-containing resin. Suitable epoxide group-containing resins are in particular resins including 1 to 10, and alternatively 2 to 10, and alternatively 2 epoxide groups per molecule. “Epoxide groups,” as used herein, refers to 1,2-epoxide groups (oxiranes). Preferably, at least one epoxide is added to the reaction mixture at weights between 0.1 and 20 wt. % and alternatively between 0.5 and 10 wt. % of the reaction mixture and further alternatively between 0.5 and 4 wt. % of the reaction mixture. The epoxy acts as a co-catalyst, however, may be added to the reaction mixture separate from the trimerization catalyst. In one embodiment, the epoxy is mixed with the essentially isocyanurate reaction mixture forming a storage stable mixture that can be catalyzed at a future time.

In one embodiment, the trimerization catalyst excludes alkylating agents. The inventor of the present application investigated the effect of alkylating agents upon the resultant isocyanurate composition and discovered a substantive decrease in mechanical properties when an alkylating agent was included. An experimental formulations were tested for fracture toughness and tensile strength. Three test specimens were prepared, a formulation corresponding to that recited in claim 1, a formulation corresponding to that recited in the claims with an addition of 2% by total weight of 2-bromobutane, and a formulation corresponding to that recited in the claims the claims with an addition of 2% by total weight of 1-2-bromobutane.

In both experiments, the compositions that included the alkylating agents performed significantly worse that the composition without the alkylating agent. With respect to the fracture toughness test, the claims isocyanurate composition achieved a median fracture toughness of 0.62K1c (MPam½) while test specimens with alkylating agent provided a lower Fracture Toughness with a K1c of 0.450.62 (MPa·m½) and K1c of 0.420.62 (MPa·m½) respectively, or about a thirty percent reduction. The tensile strength test showed even worse results when an alkylating agent was added to the composition recited in the claims. The isocyanurate composition recited in the claims achieved a median tensile strength of 105 MPa against a tensile strength of 24 MPa and 70 MPa of material modified with alkylating agents respectively, equivalent to about 75% and 33% reduction respectively.

The reaction mixture is mixed with the catalyst composition and cured through trimerization to form a cured composition essentially composed of polyisocyanurates and having a density of ≥500 and, preferably ≥1000 kg/m³. The curing reaction is, in one embodiment, carried out at elevated temperature between 50 and 200° C., or alternatively between 75 and 180° C., or further between 120 and 180° C. The reaction mixture is mixed with the catalyst composition and cured to form a cured composition essentially composed of the reaction product between two or more isocyanates which includes imides. Once mixed with the catalyst, the reaction mixture exhibits a gel time of between 10 minutes and 4 hours at ambient temperature, or alternatively between 15 minutes and 90 minutes at ambient temperature. The use of a latent catalyst can expand the gel time to days or weeks.

The trimerization of isocyanurates is known to be a slow process especially in the absence of a solvent, however, the present invention shows unexpected results of achieving a fast cure time. The present invention has shown that reaction mixture can cure in under 5 minutes while achieving mechanical properties (see Examples 2-10) comparable to those cured for longer durations (see Example 1). Rapidly curing polymers are needed for the manufacture of high-volume industries, such as the automotive industry where polymerization in under 10 minutes is desirable. The unexpectedly rapid cure further achieves high strength, stiffness and toughness. In one embodiment of the present invention the reaction mixture can cure in under 3 minutes and in another the reaction mixture can cure in 90 seconds or less.

In one embodiment, the polymerization of the predominantly aromatic isocyanate reaction mixtures yields a chemical composition including quinazolinedione. It is believed that the formation of quinazolinedione contributes to the polymers toughness and reduces the brittleness typical of aromatic polyisocyanurates.

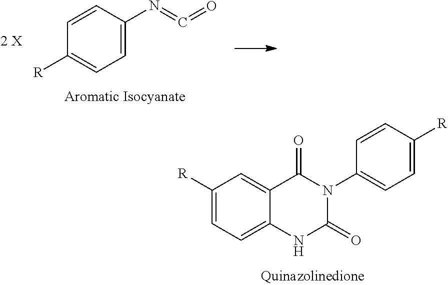

The method may also include a step of adding an internal mold release (IMR) which is important for molding and curing processes which occur in under 10 minutes. It has been found that polysiloxanes are suitable IMRs for the reduction of the adhesion of the reaction mixture with the mold or die cavity while maintaining the properties of the molded polymer matrix fiber reinforced composite materials. Polysiloxanes are produced with a range of functionalities including, methyl, hydroxyl, isocyanate, carboxylic acid, aromatic, vinyl among others which are suitable for use as an IMR. The polysiloxane may include an epoxide functional group which yields a storage stable IMR when mixed with the primarily isocyanate reaction mixture. In another embodiment, the IMR may be a natural oil or another IMR commonly used in the manufacture of composite which would be known to one skilled in the art.

The production of molded fiber reinforced composites by infusing reinforcing fibers, either continuous or discontinuous with the reaction mixture and curing the reaction mixture to form a fiber-reinforced molded part can also have useful commercial applications. Such molded parts are useful in the construction of automobiles, wind turbines, sporting goods, aerospace structures, pressure vessels, building materials, and printed circuit boards. The molded fiber reinforced composite can be used in the manufacture of suspension of automobiles (and any other structural element), wind turbine components or wind turbine spar caps, fire resistant structures, fire resistant battery boxes, aircraft interiors, fire resistant marine structures, fire resistant building materials, and printed circuit boards with high glass transition temperature. It is conceivable that the resultant binding resin of the present application used in the manufacture of these products provides even greater glass transition temperature when combined with fiber-reinforcements. The end use of the fiber-reinforced plastic molded part may be applied to other applications as would be known to one of ordinary skill in the art.

Known high-strength fiber materials suitable as fiber components for the fiber reinforced cured composition include for example carbon fibers, glass fibers; synthetic fibers, such as polyester fibers, polyethylene fibers, polypropylene fibers, polyamide fibers, polyimide fibers, polyoxazole fibers, polyhydroquinone-diimidazopyridine fibers or aramid fibers; boron fibers; oxidic or non-oxidic ceramic fibers such as aluminum oxide/silicon dioxide fibers, silicon carbide fibers; metal fibers, for example made of steel or aluminum; or natural fibers, such as flax, hemp or jute. These fibers can be introduced in the form of mats, woven fabrics, knitted fabrics, laid scrims, non-woven fabrics or rovings. It is also possible to use two or more of these fiber materials in the form of a mixture. Such high-strength fibers, laid scrims, woven fabrics and rovings are known to a person of ordinary skill in the art.

In particular, the reinforcing solids or fiber composite comprises solids or fibers in percent by volume of more than 25 vol. %, alternatively more than 50 vol. %, and alternatively between 50 and 75 vol. %, based on the total fiber composite, so as to achieve particularly good mechanical properties.

The reaction mixture may be blended with reinforcing fibers through known methods. For example, resin transfer molding (RTM), vacuum assisted resin transfer molding (VARTM), injection molding, high pressure reaction injection molding (HPRIM), wet layup, wet compression molding or prepreg technology. The invention is particularly well suited for infusion or wet compression molding due it being a room temperature liquid.

The invention describes the infusion of the reaction mixture into fibers which are pre-loaded into a molding tool such that the tool can be heated to cure reaction mixture and produce a rigid fiber reinforced composite. The method may include a resin transfer molding (RTM) method, and the reaction mixture is a reactive injection resin. “Reactive,” as used in the present context, refers to the fact that the injection resin can be chemically crosslinked. In the RTM method, providing the reaction mixture, which is to say step (1) of the described method, can include loading, and in particular injecting, the injection resin into a molding tool. When fiber-reinforced plastic parts are being produced, for which the described methods and reaction mixtures are particularly suitable, fibers or semi-finished fiber products (prewovens/preforms) can be placed in the molding tool prior to injection. The fibers and/or semi-finished fiber products used can be the materials known for this application in the prior art, and in particular carbon fibers.

The reaction mixture may be injected at pressure above ambient into a mold or die heated to between 80 to 200° C., or alternatively between 120 and 180° C., or further between 120 and 160° C. containing continuous or discontinuous fibers using through resin transfer molding and cured in a period of time less than 10 minutes or in another embodiment 5 minutes or less. Alternatively, the reaction mixture can be injected into a mold containing continuous or discontinuous fibers through resin transfer molding and cured in under 2 minutes. The cured composites can also be manufactured through HP-RTM and used in automotive suspensions. In one embodiment, the cured composites are manufactured through HP-RTM and applied as leaf springs in automotive applications. In another embodiment, the cured composites are manufactured through HP-RTM and applied as structures to absorb the energy of a crash in automobiles. Still further, other structural elements, such as, for example vehicle frames, and any other vehicle structural element may be produced using the chemical composition and reaction mechanisms of the present application.

In another embodiment of the invention, a pultrusion die can be used to manufacture uniform cross section parts in a continuous process where the reinforcing fibers are continuously fed into a heated die, the catalyzed reaction mixture is injected into the heated die containing the fibers such that the reaction mixture cures as the fibers pass through the die allowing a rigid fiber reinforced composite to exit the die. The pultrusion process is carried out with the die at elevated temperature between 50° C. and 200° C., or alternatively between 120° C. and 180° C., or further between 120° C. and 160° C. Pultruded composites are useful in many applications including spar caps in wind turbines, utility poles, rebar, rocket motor cases, automotive frames and bumpers, rigid tubing, structural framing, as well as numerous other applications that would be known to one skilled in the art. In one embodiment, the reaction mixture is infused into reinforcing fibers and cured in a continuous pultrusion process where the cured composite is applied as leaf springs in automotive applications. In another embodiment, the reaction mixture is infused into reinforcing fibers and cured in a continuous pultrusion process where the cured composite is applied as a bumper in automobiles.

In another embodiment of the invention, the fibers can be wet infused through a resin bath or direct injection box and subsequently wound onto a mandrel such that the mold is internal to the reinforcements, commonly known as filament winding. The internal mandrel can be removed, left as additional reinforcement or to provide a barrier impermeable to certain gasses. Filament wound composites are useful in many applications including pressure vessels, rocket motor cases, piping, structural tubes, as well as numerous other applications that would be known to one skilled in the art.

Specifically, the reaction mixture can be injected into wind turbine blade mold containing continuous or discontinuous fibers through resin transfer molding and cured at a temperature below 95° C.

The cured composition created using the methods disclosed herein can be flame retardant. The cured composition created using the methods disclosed herein can also be non-flammable. The non-flammable properties of the composite are obtained without the incorporation of halogenated compounds, organophosphorus compounds or minerals.

The method may involve resin transfer molding to prepare molded high strength fiber reinforced composites using a low viscosity essentially isocyanate reaction mixture in under 10 minutes by heating to temperatures above 150° C. or at low temperature (<95° C.) in under 2 hours. The method further obtains polymers with an incredibly high glass transition temperature independent of the cure temperature whereas common thermosetting resins achieve a glass transition temperature proportional to the cure temperature. Furthermore, the method demonstrates that the presence of aliphatic uretdione, aliphatic trimer, or aliphatic iminooxadiazinedione in the reaction mixture accelerates the polymerization leading to greater isocyanate conversion whereas common expectations would indicate the presence of an aliphatic component would reduce reactivity. This method further shows that the polymerization reaction can reach completion in minutes making the polymer compatible with mass production.

### EXAMPLES

Molded fiber reinforced composites were produced from the infusion of primarily isocyanate reaction mixtures into fiber placed into a molded or die through the following methods. A polymeric methylene diphenyl diisocyanate (p-MDI) under the trade name LUPRANATE M20 from BASF which according to the material MSDS consists of <55% oligomeric MDI and 38% monomeric 4-4 Diphenylmethane Diisocyanate and <10% MDI isomers and an average isocyanate functionality of 2.7. HDI uretdione was obtained from Covestro under the trade name DESMODUR N3400 and HDI Trimer was obtained from BASF under the trade name Basonat HI-100. Phenyl glycidyl ether (GPE) at >99% purity was acquired from TCI Chemicals and cresyl glycidyl ether (CGE) was obtained from Evonik under the trade name Epodil 742. N-Benzyldimethylamine (BDMA) was obtained from Alfa Aesar at >98% purity, 1,4-diazabicyclo[2.2.2]octane (DABCO) was obtained from TCI Chemicals at >98% purity, Nitrobenzene was obtained from TCI Chemicals at >99.5% purity and Benzonitrile was obtained from TCI Chemicals at >99% purity. All chemicals were used as received.

The selected isocyanates for a chosen reaction mixture were mixed using a vortex mixer and the catalytic epoxy was added to the solution. The mixture was further blended using a Fisher Vortex Genie 2 vortex mixer for 1 minute. The catalyst was then added to the mixture at a desired concentration and blended using the vortex mixer for 1 minute. The solution was subsequently centrifuged at 5000 rpm for 2 minutes using a Thermo Scientific Sorvall Legend X1 centrifuge to remove air introduced during mixing. Other common methods of degassing samples may also be used (i.e., vacuum pressure, sonication).

The catalyzed reaction mixture was then infused into a fiber preform through wet layup or vacuum assisted resin transfer molding (VARTM) although other manufacturing methods such as HP-RTM or Pultrusion may be used. Vacuum was applied across the fibers from the resin solution and the liquid resin was pulled through to impregnate the fibers. Composites were manufactured with 300 gsm 8-harness satin weave E-Glass fabric, unidirectional 12 k 373 gsm Mitsubishi Grafil carbon fiber, unidirectional non-crimp 50 k 800 gsm Zoltek PX35 carbon fiber, unidirectional 12 k 300 gsm Hexcel IM2 carbon fiber and unidirectional non-crimp fiberglass 1200 gsm E-glass. Once the fibers were infused, the vacuum bagged layup was placed in an autoclave preheated to 160° C. which was immediately pressurized to 100 psig, then depressurized back to ambient such that the composite could be removed within three minutes, at which point the composite panel was immediately removed from the vacuum bag, separated from the mold and allowed to cool. This process was carried out such that the composite was only subject to heat for 3 minutes.

Composite panels cured at 160° C. for 3 minutes were tested for their short beam strength (ASTM 2344) and Mode 1 fracture toughness (ASTM 5528). The composites were testing on an Instron Load frames according to the ASTM Standard with the fracture testing pre-cracking the specimens before unloading and then reloading and using the modified compliance method of ASTM D6115 to calculate the delamination resistance curves.

### Example 1

Fiberglass composites were manufactured by wet layup of a 24×24 in. 300 gsm 8-harness satin weave E-Glass fabric. The reaction mixture consisted of LUPRANATE M20 with 2% by weight GPE blending into the pMDI before adding 2% by weight BDMA. This reaction mixture has a low viscosity of ˜200 cP and provides a working life of approximately 2 hours. Once the fabric was fully wet with the isocyanate resin, the panel was vacuum bagged and cured in an autoclave which was ramped to 120 C at 3° C. per minute then held at 120° C. for 2 hours before cooling at 3° C. per minute. The fiberglass panel had a thickness of 0.25 in. and was cut using a diamond saw to allow FST testing and short beam strength testing.

### Examples 2-5

Fiber reinforced composites were manufactured by VARTM using unidirectional 12 k 373 gsm Mitsubishi Grafil carbon fiber (Example 2), unidirectional non-crimp 50 k 800 gsm Zoltek PX35 carbon fiber (Example 3), unidirectional 12 k 300 gsm Hexcel IM2 carbon fiber (Example 4) and unidirectional non-crimp fiberglass 1200 gsm E-glass (Example 5). The resin in all examples consisted of LUPRANATE M20 with 3% by weight Epodil 742 blended into the pMDI before adding 2% by weight of 1:3 DABCO:benzonitrile solution. The VARTM process was allowed to be completed over a period of a 2-10 minutes before curing the panels in the autoclave at 100 psi for 3 minutes at 170° C. or in a hot press at 170° C. for 3 minutes. After inserting the composite in the autoclave, it was sealed and immediately pressurized reaching 100 psi approximately 90 seconds after incorporating the vacuum bagged composite and then held at pressure for approximately 15 seconds before venting such that the autoclave door could be opened and the composite removed after 180 seconds at temperature. After removal from the autoclave the cured composite was immediately removed from the flat plate and vacuum bag then allowed to cure under ambient conditions. This process was meant to simulate HP-RTM processing and demonstrated the cure of a cold resin in 3 minutes whereas high pressure injection systems allow the resin to be heated prior to introduction to the mold which would greatly accelerate the cure.

### Example 6

Fiberglass composites were manufactured by VARTM using Vectorply E-LT 2900 non-crimp E-Glass fabric with a total weight of 1062 gsm (948 gsm in the 0° direction and 114 gsm in the 90° direction). The resin consisted of LUPRANATE M20 with 16% by weight DESMODUR N3400 and 2% by weight GPE blended into the pMDI before adding 2% by weight of a 1:2:2 DABCO:BDMA:Benzene catalyst solution. The panel was infused at room temperature on a heated flat mold and once infusion was complete the part was heated to 85° C. at 3° C./min and held at 85° C. for 2 h before allowing to cool to room temperature.

### Example 7-10

Example 2 was repeated however with the inclusion of polysiloxane IMR with methyl (Example 7), isocyanate (Example 8), hydroxyl (Example 9) and Epoxy (Example 10) functional groups. Carbon fiber composites were manufactured by VARTM using unidirectional 12 k 373 gsm Mitsubishi Grafil carbon fiber and tested for their short beam strength.

The composite properties were characterized using short beam shear strength measurements since this test is representative of the properties of the polymer matrix and demonstrates the resistance to shear failure. One measure material ability to withstand shear failure is a test to determine short beam strength. The short beam strength of Examples 1-7 and 10 are shown in Table 2. The results of the measurements show the polymer can achieve excellent mechanical properties. Table 2 also shows the glass transition temperature (Tg) as measured by a dynamic mechanical analyzer (DMA) which demonstrates that the composite can achieve a Tg independent of the cure temperature, Examples 1 and 6 were cured at 120° C. while Examples 2-5 were cured at 170° C. in 3 minutes. In addition to the short beam strength, the Mode I fracture toughness was measured for Example 2. FIG. 1 shows the fracture toughness of the carbon fiber composite cured in at 170° C. in 3 minutes and demonstrates a G_{1C} value averaging 0.65 KJ/m² which is very high and exceeds many toughened epoxy's such as Hexcel's 8552 with IM7 carbon fiber prepreg which only achieves a G_{1C} of approximately 0.3 KJ/m² and requires a cure at 110° C. for 1 hour followed by 2 hours at 180° C. whereas the present invention cures at 170° C. in under 5 minutes.

TABLE 2
Short beam strength of composite specimens.

| | Short Beam Strength | | Glass Transition Temperature | |
|---|---|---|---|---|
| Example 1 | 48.36 ± 4.24 | MPa | — | |
| Example 2 | 69.0 ± 3.68 | MPa | 212.1° | C. |
| Example 3 | 79.3 ± 2.70 | MPa | 207.5° | C. |
| Example 4 | 79.9 ± 2.28 | MPa | 216.85° | C. |
| Example 5 | 72.4 ± 3.80 | MPa | 212.5° | C. |
| Example 6 | 60.6 ± 7.07 | MPa | 181.7° | C. |
| Example 7 | 69.54 ± 1.64 | MPa | — | |
| Example 9 | 80.24 ± 3.41 | MPa | — | |
| Example 10 | 95.9 ± 3.03 | MPa | 197.07° | C. |

TABLE 3
Tensile Strength of neat polymer with
polysiloxane internal mold release.

| | Neat Polymer Tensile Strength | |
|---|---|---|
| Examples 2-5 | 111.1 ± 9.99 | MPa |
| Example 6 | 98.5 ± 6.37 | MPa |
| Example 7 | 103.0 ± 5.83 | MPa |
| Example 8 | 104.4 ± 5.67 | MPa |
| Example 9 | 103 ± 5.83 | MPa |
| Example 10 | 92.22 ± 5.41 | MPa |

Fracture toughness as a function of the crack length accounting for the modified compliance method of ASTM D6115 for Example #2.

Obviously, many modifications and variations of the present invention are possible in light of the above teachings foregoing invention has been described in accordance with the relevant legal standards; thus, the description is merely exemplary rather than limiting in nature. Variations and modifications to the disclosed embodiment may become apparent to those skilled in the art and do come within the scope of the invention. Accordingly, the scope of the legal protection afforded this invention can only be determined by studying the following claims. The invention has been described in an illustrative manner, and it is to be understood that the terminology, which has been used, is intended to be in the nature of words of description rather than of limitation.

What is claimed is:

1. A method of producing a reinforced polymer composite, comprising the steps of:
providing a die defining a die cavity;
providing reinforcement solids;
providing a liquid reaction mixture including an aromatic polyisocyanate and initiating reaction of said aromatic polyisocyanate by infusing a catalyst composition thereby forming an aromatic isocyanurate based polymer reaction mixture;
impregnating reinforcing solids with said isocyanurate reaction mixture and using said cavity for forming said aromatic isocyanurate based polymer reaction mixture thereby impregnating said reinforcing solids; and
heating the cavity defined by the die to at least 80° C. for a period required to form a polymer reaction product comprising said reinforcing solids thereby producing said reinforced polymer composite and removing said reinforced polymer composite from said cavity.

2. The method set forth in claim 1, wherein said step of forming an aromatic isocyanurate based polymer reaction mixture is further defined by combining methylene diphenyl diisocyanate (MDI) and polymeric methylene diphenyl diisocyanate (pMDI) such that the an average functionality is greater than 2.

3. The method set forth in claim 1, wherein said step of forming an aromatic isocyanurate based polymer reaction mixture is further defined by said reaction mixture comprising a catalytic amount of epoxy while being substantially free of polyols and polyamines.

4. The method set forth in claim 1, wherein said step of forming an aromatic isocyanurate based polymer reaction mixture is further defined by providing a polymeric methylene diphenyl diisocyanate and a catalytic amount of epoxy while being substantially free of molecules containing active hydrogen moieties such as hydroxyls, primary and secondary amines, carboxylic acids, and thiols.

5. The method set forth in claim 4, further wherein said step of producing a reinforced polymer composite is further defined by producing a composite providing a glass transition temperature of greater than 160° C.

6. The method set forth in claim 1, further including a step polymerizing a reaction mixture containing essentially polymeric methylene diphenyl diisocyanate including a catalytic amount of epoxy with a trimerization catalyst thereby causing the polymeric methylene diphenyl diisocyanate to trimerize being substantially free of molecules containing active hydrogen moieties including hydroxyls, primary and secondary amines, carboxylic acids, and thiols.

7. The method set forth in claim 6, wherein said step of polymerizing the reaction mixture is further defined by polymerizing the reaction mixture in the presence of aliphatic uretdione, aliphatic trimer, or aliphatic iminooxadiazinedione which are reaction products of two or three aliphatic isocyanates thereby accelerating polymerization of the reaction mixture and reducing cure temperature.

8. The method set forth in claim 1, wherein further including a step of providing the isocyanate reaction mixture an average isocyanate functionality greater than one of 2.1, 2.2, 2.5 and 2.7.

9. The method set forth in claim 1, wherein said step of providing a reaction mixture is further defined by providing aromatic isocyanates comprising monomeric MDI and Toluene Diisocyanate (TDI).

10. The method set forth in claim 1, wherein said step of curing said isocyanurate reaction mixture is further defined by curing said isocyanurate reaction mixture using triethylenediamine in less than about five minutes thereby providing a glass transition temperature of greater than about 180° C. to said reinforced polymer composite.

11. The method set forth in claim 1, wherein an internal mold release (IMR) is added to said liquid reaction mixture.

12. The method set forth in claim 1, wherein said catalytic amount of epoxide comprises less than about 10% by weight of said aromatic isocyanurate.

13. The method set forth in claim 1, wherein said catalytic amount of epoxide comprises less than a bout 7.5% by weight of said aromatic isocyanurate.

14. The method set forth in claim 1, wherein said catalytic amount of epoxide comprises less than about 5% by weight of said aromatic isocyanurate.

15. The method set forth in claim 1, wherein said step of providing a liquid reaction mixture is further defined by providing a catalytic amount of epoxy followed by providing and a trimerization catalyst comprising triethylenediamine.

16. The method set forth in claim 1, wherein said catalyst composition includes at least one epoxide being at least one of monofunctional and polyfunctional including a proportion to the total reaction mixture of about 2%.

17. The method set forth in claim 1, wherein said catalyst composition includes Triethylenediamine.

18. A structural element, comprising:
reinforcing solids;
a polymeric composition encapsulating said reinforcing solids; and
said polymeric composition formed from an aromatic isocyanurate, a catalytic amount of epoxide and a trimerization catalyst thereby generating an isocyanurate amide and quinazolinedione composition having a glass transition temperature of at least about 160° C.

19. The structural element recited in claim 11, wherein said polymeric composition encapsulating said reinforcing solids consists essentially of a reaction product of methylene diphenyl diisocyanate (MDI) and polymeric methylene diphenyl diisocyanate (pMDI) includes a functionality greater than 2.

20. The structural element recited in claim 1, further comprising a glass transition temperature of greater than about 160° C.

21. The structural element of claim 11, wherein said polymeric composition encapsulating said reinforcing solids comprises a tensile strength of greater than 92 MPa and a short beam strength of greater than 55 MPa.

22. The structural element of claim 11, wherein said reinforcing solids comprise greater than about 25% by volume of said structural composite.

23. The structural element of claim 11, wherein said reinforcing solids comprise greater than about 50% by volume of said structural composite.

24. The structural element of claim 11, wherein said reinforcing solids comprise between about 50% and 75% by volume of said structural composite.

25. The structural element recited in claim 11, wherein said reinforcing solids comprise at least one of fiberglass, carbon, kevlar, basalt, boron, SiC or ultrahigh molecular weight polyethelene fibers, being either chopped or continuous.

26. The structural element recited in claim 11, wherein said structural element is non-flammable.

27. The structural element recited in claim 11, is further defined as an automobile chassis component.

28. The structural element of claim 11, further comprising a Mode I fracture toughness greater than about 0.3 kJ/m².
